(19) United States
(12) Patent Application Publication
(10) Pub. No.: US 2008/0003980 A1
(43) Pub. Date: Jan. 3, 2008

(54) SUBSIDY-CONTROLLED HANDSET DEVICE VIA A SIM CARD USING ASYMMETRIC VERIFICATION AND METHOD THEREOF

(75) Inventors: Joel D. Voss, Elkhorn, WI (US); Kent D. Rager, Gurnee, IL (US)

Correspondence Address: MOTOROLA INC.;C/O VEDDER PRICE KAUFMAN & KAMMHOLZ, P.C., 222 N. LASALLE ST, CHICAGO, IL, 60601, US

(73) Assignee: Motorola, Inc., Schaumburg, IL (US)

(21) Appl. No.: 11/428,171

(22) Filed: Jun. 30, 2006

(51) Int. Cl. H04M 1/66

(52) U.S. Cl. 455/411

(57) ABSTRACT

A handset device (100) enabled for subsidy control via a SIM card (150) includes memory (110) operative to store an activation file (112) and a public key (114) and a controller (120) operatively coupled to the memory. The controller (120) is operative to send an activation file request to a SIM card (150), to receive an asymmetrically digitally signed activation file (214) from the SIM card (150), to verify the asymmetric digital signature of the activation file (214) via the public key (114) and to install the activation file (112) in the memory (110). A SIM card device (150) enabled for subsidy control of a handset device (100) includes memory (110) operative to store an activation file template (162) and a private key (164) and a controller (170) operatively coupled to the memory (160). The controller (170) is operative to receive an activation file request (212) from a handset device (100), to bind an activation file template 162 to the handset device to generate a bound activation file, to asymmetrically digitally sign the bound activation file via the private key (164) to generate an asymmetrically digitally signed activation file (214), and to send the asymmetrically digitally signed activation file (214) to the handset device (100). Related methods are also disclosed.

### FIELD OF THE INVENTION

The invention relates generally to wireless network handset devices and, more particularly, to wireless network handset devices enabled for subsidy control.

### BACKGROUND OF THE INVENTION

Wireless communication handsets are typically manufactured to be capable of operating on a variety of service provider networks. To personalize a handset to a specific network provider and customer, a device called a subscriber identity module, or SIM, card is inserted into the handset. SIM cards hold data parameters, such as home public land mobile network (HPLMN), international mobile subscriber identifier (IMSI), and group identifiers (GID1/GID2), that are coded with values that bind the handset to the issuing service provider and the customer. When a service provider sells a service agreement, the purchasing customer is typically provided a handset with a pre-installed, personalized SIM card.

Wireless communication network service providers frequently provide these handsets, such as cellular telephones, to new customers at deep discounts as an enticement to sign long term service agreements. In this case, the service provider essentially sells the handset to the new customer at a loss, called a subsidy. This subsidy represents a substantial investment that the service provider hopes to recover from the customer in the form of user fees to be collected over the life of the service agreement.

The subsidy is a marketing investment that the service provider seeks to protect via a SIM lock or subsidy lock. A subsidy lock is used insure that a subsidized handset can only be used with the operator's SIM cards; though such a phone could still obtain roaming service on another network with which the home operator has a roaming agreement. Various hardware or software techniques are used to insure that the handset can only accept SIM cards issued by the subsidizing operator. The subsidy locking mechanisms must be very robust to prevent sophisticated hackers from circumventing the subsidy lock, replacing the SIM card, and then reselling a subsidized handset to a user of another network. At the same time, the subsidy locking mechanisms must be configured to easily allow a customer to unlock the phone via a password at the end of the service agreement should the customer choose to switch to a different service provider.

Subsidy locking implementations may use hardware designs supporting “secure boot” functionality and “secret key” hardware encryption. A “secure boot” capability utilizes asymmetric digital signatures, whereby the root of trust is embedded in the hardware to validate that the device software is authentic before executing it. This validation insures that the software has not been modified by hackers to bypass the security checks of the SIM-lock implementation. If the software is indeed modified, then it must be re-signed in order to pass the secure boot process. The digital signing process requires a private encryption key which is kept on a secure signing server at the manufacturer, not within the handset. Thus, unauthorized persons do not have knowledge of this key and hence cannot generate a new signature on code that they may have modified. A limitation of secure booting is that signed code is fixed and cannot be altered.

“Secret key” hardware encryption involves a symmetric encryption algorithm, such as 3DES, implemented in hardware utilizing a key variable contained in that hardware. This key variable is randomly assigned to each device, such that it is different between each device. No records are kept to track which key value was assigned to each part. Furthermore, there are no hardware or software interfaces that can read the value of this key. Thus, the key is a secret hidden in the hardware. Hardware encryption using this key is useful for encrypting data for the purpose of integrity protection and for secrecy of that data for storage in external memory. Because the encryption key is random, data cannot be copied into another device—it will only decrypt successfully on the original device. In addition, protected data cannot be altered outside of the chip containing this hardware encryption since it would require re-encrypting using the secret key.

The subsidy locking, or SIM-lock, feature involves several data parameters that must be protected from tampering (i.e. from unauthorized modification). Among these is a lock state that indicates if the handset is locked or unlocked. In addition, if the handset is locked, there are parameters (such as a PLMN list, IMSI digits, GID1 and GID2 values, etc.,) that indicate which SIM cards are allowed. The handset user must be able to unlock the subsidy lock by entering a password at the completion of the contract term. Such passwords are randomly assigned to each handset and tracked in a secure database. Because the lock state parameter must change during this unlocking process, these parameters may be protected via symmetric encryption utilizing a secret hardware encryption key as described above.

Symmetric encryption can be very effective in preventing unauthorized unlocking provided that there are not any security vulnerabilities in the handset software. However, it is very difficult, if not impossible, to eliminate all vulnerabilities. Most importantly, all of the information, such as the secret hardware encryption key, necessary to compute the values that represent the unlocked state is hidden in the product. Therefore, a hacker may be able to find a security vulnerability that tricks the handset into computing the proper encrypted value representing the unlocked state. For example, it may possible to execute software code that processes a correct password entry by convincing the handset software that a user has already entered a correct password. Other potential security vulnerabilities, such as buffer overflows, or signed-integer math overflows/underflows, may be exploited to allow the execution of software that was not validated by the secure boot checking. Non-validated software could then make use of the hardware encryption capability on the handset to encrypt and store a value representing the unlocked state. It is therefore very useful to provide a more secure method for protecting subsidy locking parameters in handset devices by removing the “secret key” from the handset device.

### BRIEF DESCRIPTION OF THE DRAWINGS

The present invention and the corresponding advantages and features provided thereby will be best understood and appreciated upon review of the following detailed description of the invention, taken in conjunction with the following drawings, where like numerals represent like elements, in which:

FIG. 1 is a schematic block diagram of an apparatus employing one example of subsidy control of a handset device via a SIM card in accordance with one embodiment of the invention;

FIG. 2 is a flowchart illustrating one example of a method of subsidy control of a handset device via a SIM card in accordance with one embodiment of the invention;

FIG. 3 is a flowchart illustrating one example of a method of subsidy control of a handset device via a SIM card in accordance with one embodiment of the invention;

FIG. 4 is a flowchart illustrating one example of a method of subsidy control of a handset device via a SIM card in accordance with one embodiment of the invention;

FIG. 5 is a flowchart illustrating one example of a method of subsidy control of a handset device via a SIM card in accordance with one embodiment of the invention;

FIG. 6 is a flowchart illustrating one example of a method of subsidy control of a handset device via a SIM card in accordance with one embodiment of the invention;

FIG. 7 is a flowchart illustrating one example of a method of subsidy control of a handset device via a SIM card in accordance with one embodiment of the invention;

FIG. 8 is a flowchart illustrating one example of a method of subsidy control of a handset device via a SIM card in accordance with one embodiment of the invention;

FIG. 9 is a flowchart illustrating one example of a method of subsidy control of a handset device via a SIM card in accordance with one embodiment of the invention; and

FIG. 10 is a flowchart illustrating one example of a method of subsidy control of a handset device via a SIM card in accordance with one embodiment of the invention.

### DETAILED DESCRIPTION OF THE INVENTION

A method provides improved security for subsidy control of a handset device, such as a cellular telephone, by among other things, using asymmetric digital signature verification to verify an activation file. In an exemplary embodiment of the present invention, a handset device is enabled for subsidy control via a SIM card. The handset is operative to send an activation file request to the SIM card, to receive an asymmetrically digitally signed activation file from the SIM card, and to verify the asymmetric digital signature of the activation file via the public key and to install the activation file in handset memory. In another exemplary embodiment of the present invention, a SIM card device is enabled for subsidy control of a handset device. The SIM card device is operative to receive an activation file request from a handset device, to bind an activation file template to the handset device to thereby generate a bound activation file for the handset, to asymmetrically digitally sign the bound activation file via a private key to thereby generate an asymmetrically digitally signed activation file; and to send the asymmetrically digitally signed activation file to the handset device.

As such, a method and apparatus is disclosed that enhances SIM-locking security by insuring that the handset device does not contain all of the critical information necessary for generating the unlock state. In particular, the asymmetric digital signature on the activation file that governs subsidy locking is generated using a private key that that is not contained in the handset device. Therefore, even if a hacker manages to get unauthorized software code to execute on the handset device, critical information needed to unlock the phone is simply not available in any form on the device. In addition, by binding the signed activation file to the handset device, the activation file may only be used to activate a single handset. Further, the responsibility of password management is moved from the handset manufacturer to the network operator, or eliminated if password-less subsidy unlock is used. Other advantages will be recognized by those of ordinary skill in the art.

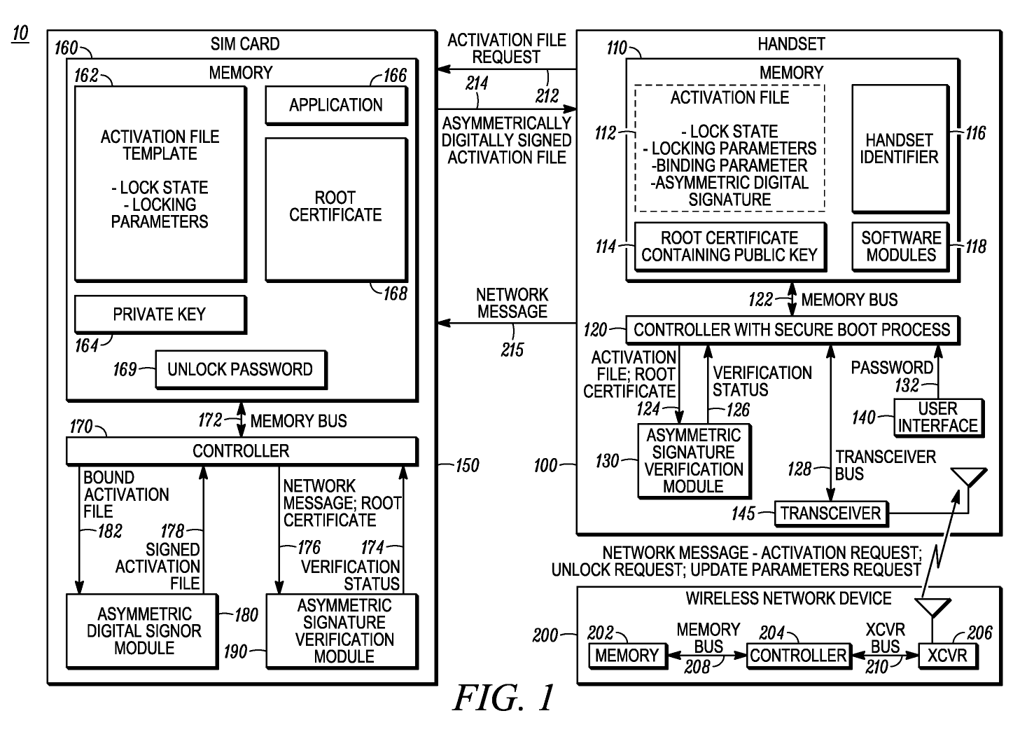

FIG. 1 is a schematic block diagram of an apparatus 10 employing one example of subsidy control of a handset device 100 via a SIM card 150 in accordance with one embodiment of the invention. The handset device 100 may be embodied as any suitable mobile communication device including, but not limited to, a cellular telephone, an internet appliance, a laptop computer, a palmtop computer, a personal digital assistant, a digital entertainment device, a radio communication device, a tracking device, a personal training device, or a combination thereof. The SIM card 150 may be a smart card capable of executing a subsidy locking method. The SIM card 150 may be operable for insertion into the handset device 100 or other operable coupling to the handset device 100. A wireless network device 200 may be embodied as any suitable operating device in a wireless network including, but not limited to, a base station, a hub, a repeating transmitter, a mobile station, or combinations thereof.

In particular, the handset device 100 is preferably a device that connects to a wireless communications service, such as a cellular telephone service. For purposes of illustration only, a cellular telephone handset device 100 is exemplified, and includes: a controller 120 memory 110 including an activation file 112, a root certificate containing a public key 114, a handset identifier 116; and software modules 118; an asymmetric signature verification module 130; a user interface 140; and a transceiver 145 In this example, the controller 120 executes software instructions obtained from the memory 110 via a memory bus 122 to control the operation of the handset device 100. The controller 120 is operatively coupled to the memory 110, the asymmetric signature verification module 130, the user interface 140, and the transceiver 145. Alternatively, signature verification may be performed by the controller 120.

In this example, the controller 120 may be, for example, a DSP, microcontroller, central processing unit, baseband processor, co-processor, or any suitable processing device. In addition it may be discrete logic, or any suitable combination of hardware, software or firmware or any suitable structure. The controller 120 is preferably implemented with a “secure boot” capability. During securing booting, the controller 120 verifies all executed code, such as software modules 118, against a root of trust embedded in the hardware prior to execution. For example, a root certificate embedded in the software image may be verified by the secure boot, using a chain of trust rooted in a hardware root public key. The root certificate is used to validate the signature on an operator root certificate file, which is then used to validate the signature on an activation file 112. This secure booting method insures that code in the memory 110 has not been modified by hackers to bypass the security checks of the subsidy locking implementation. If a software modification is detected, then the code would need to be re-signed using a private key in order to pass the secure boot process. The private key is not held in the handset device 100 so that the handset device 100 cannot digitally sign any software. Likewise, without access to the private key, malicious code cannot be run in the handset device 100 to generate an activation file 112 with a valid asymmetric digital signature that will verify against the public key 114.

A dedicated asymmetric signature verification module 130 may be operatively coupled to the controller 120 for the purpose of performing signature verification. For example, an asymmetrically digitally signed activation file 212 and a public key 114 may be passed to the asymmetric signature verification module 130 for verification. The verification status 126 may be passed back to the controller 120. Alternatively, asymmetric signature verification may be performed by the controller 120 rather than via a separate asymmetric signature verification module 130. A user interface 140 may be operatively coupled to the controller 120. This user interface 140 provides a means for user input of a password 132 for use in subsidy unlocking of the handset device 100.

A transceiver 145 provides a means for wireless communication between the handset device 100 and the wireless network device 200. Any suitable wireless communication band, format, and topology may be used as is known in the art of wireless communication. The transceiver 145 may be operatively coupled to the controller 120 via a transceiver bus 128. For example, the controller 120 may use the transceiver to transmit information from the handset device 100 to the wireless network device 200 where this information may be further routed and directed to a receiving unit, such as a handset device of another user. The transceiver 145 also receives information from the wireless network device 200. In particular, network messages, including messages for subsidy control may be transmitted by the wireless network device 200 to the handset device 100. In this way, the handset device 100 may receive network messages, such as an activation request, an unlock request, or an update parameters request, from the network operator as a means of controlling the subsidy of the handset device 100.

Operational instructions, or software, executing on the controller 120 is stored in memory 110 that may include a single memory device or a plurality of memory devices. Such memory 110 may include any memory element that stores digital data including, but not limited to, RAM, ROM, flash memory, hard disk drive, distributed memory such as servers on a network, or CD-ROM or any suitable storage medium. It will be recognized that such memory may be integrated with the controller or take any suitable configuration.

The memory 110 is operative to store an activation file 112. The handset device 100 may be manufactured with an empty activation file 112 and with the handset device 100 set to a default state where the handset is subsidy locked but will not operate on any operator network until a valid activation file 112 has been stored. While the activation file 112 is described as a file, it may be any grouping of binary data such as, but not limited to a data stream, data block, binary file, or other data structure as are known in the art.

A root certificate containing the public key 114 may be stored in the memory 110 of the handset device 100. The root certificate 114 may be securely stored in such a way as to prevent overwriting of its contents, or to prevent copying its contents to another handset 100. The public key with the root certificate 114 provides a means for the handset 100 to verify an asymmetric digital signature of any file or data block that is provided to the handset 100 from a signor holding a paired private key. For example, a wireless network operator may provide the handset 100 manufacturer with a root certificate containing a public key 114 and request that the root certificate containing a public key 114 be provisioned into a handset device 100. The wireless network operator may then subsidize the sale of this handset 100 to a customer who signs a service contract to use the wireless network. The root certificate 114 may be provisioned to the handset device 100 in a manner such that it is digitally signed by the manufacturer and bound to the handset identifier 116, such as the serial number or IMEI, thereby preventing the root certificate 114 from being used by another handset 100. The handset identifier 116 could be a value stored in the memory. It could also be a unique value embedded in the controller. In fact, it is preferably the unique ID value of the controller, since a serial number or IMEI are provisioned into the phone and could potentially be duplicated into multiple handsets. The bound signature of the root certificate 114 may be validated by the handset controller 120 during secure booting or during the subsidy lock status checking which could occur after the secure boot process is complete.

To insure that a subsidized handset 100 is actually used on the subsidizing operator's network, the handset device 100 may further be manufactured with a default subsidy locked state and with no network operator specific SIM lock data. In this way, the handset 100 is effectively subsidy locked to not operate on any network. The handset device 100 may be further manufactured to only operate for emergency calling (911) or in a special test SIM mode until a valid activation of the handset occurs. The activation feature is useful to secure handsets while in transit to the operator—if stolen they are of no use until activated by an operator SIM card.

To activate the handset device 100, the handset device 100 must receive and verify an asymmetrically digitally signed activation file 214 that has been signed using a private key that is paired to the public key contained in the root certificate 114. The handset device 100 verifies the signature of the activation file 214 using the root certificate containing the public key 114. This verification may be performed by the controller 120 or by the dedicated asymmetric signature verification module 130. Subsidy security is insured by verifying the signature of the activation file 214 against a trusted certificate 114. This verification may be a single level, where the digital signature of the activation file 214 is verified against the root certificate containing the public key 114. Alternatively, the activation file 214 may further contain a certificate chain, consisting of one or more certificates, where each certificate is verified against a previously validated certificate in a hierarchy. For example, the activation file 214 may include an intermediate certificate and a device certificate in addition to the digital signature. The handset would use the root certificate 114 to first validate the received intermediate certificate. The validated intermediate certificate would then be used to validate the received device certificate. The validated device certificate would then be used to validate the signature of the activation file 214.

If the handset device 100 verifies the activation file 214, then the contents of the file 214 may be stored into the activation file 112 in the handset memory 110. The handset 100 is thereby activated for use while now being subsidy locked to a particular operator network, or other locking parameter, as specified in the stored activation file. If the stored activation file 112 indicates a locked state, then it also specifies which SIM cards are accepted. If the activation file 112 specifies an unlocked state, then any SIM card is accepted. In addition to verifying the signature of the activation file 214, the handset device may verify that the activation file 112 is bound to the particular handset 100 each time the subsidy lock status is checked (i.e. each power-up or SIM insertion). If the signature of the stored activation file 112 does not verify, then only test SIM cards are accepted for use in the handset device 100. While the asymmetrically digitally signed activation file 214 is described as a file, it is understood that it may be any grouping of binary data such as, but not limited to a data stream, data block, binary file, or other data structure as are known in the art.

A handset identifier 116 may be stored in the handset memory 110. Preferably, the handset identifier 116 would be an unchangeable unique ID value stored in the controller IC that was programmed there by the controller IC manufacturer. During activation, the handset device 100 may send an activation file request 212 including this handset identifier 116. The signing device, such as the SIM card 150, may generate an asymmetrically digitally signed activation file 214 with the handset identifier 116 bound to the signed file by, for example, including the handset identifier 116 in the activation file template 162 prior to digital signing. The handset identifier 116 may be generated during manufacturing of the handset 100 or of the handset components such that each handset 100 has a unique identifier 116. For example, a unique ID of the controller IC may be stored in the controller IC by the manufacturer of the controller IC. As a result, the asymmetrically digitally signed activation file 214 generated by the signing device can only be used to activate one handset device—the device 100 that is coupled to that signor.

The SIM card 150 is a smart card enabled for subsidy control of a handset device 100. The SIM card 150 may include memory 160 operative to store an activation file template 162, a private key 164, a software application 166, a certificate chain 168, and an unlock password 169. The SIM card 150 may include a controller 170 operatively coupled to the memory 160 through a memory bus 172. The controller 170 may be operative to receive an activation file request 212 from the handset device, to bind the activation file template 162 to the handset device 100 to thereby generate a bound activation file 182, to asymmetrically digitally sign the bound activation file 182 via the private key 164 to thereby generate an asymmetrically digitally signed activation file 178 and 214; and to send the asymmetrically digitally signed activation file 214 to the handset device 100. The SIM card 150 may further be limited to activating a single handset device 100 to thereby enhance subsidy security. The controller may be operatively coupled to an asymmetric digital signor 180 and to an asymmetric signature verification module 190.

In this example, the controller 170 may be, for example, a DSP, microcontroller, central processing unit, baseband processor, co-processor, or any suitable processing device. In addition it may be discrete logic, or any suitable combination of hardware, software or firmware or any suitable structure. The controller 170 may also be implemented with a secure boot capability.

A dedicated asymmetric digital signor module 180 may be operatively coupled to the controller 170 for the purpose of signing the bound activation file 178. The controller 170 provides the bound activation file 182 and the private key 164 to the asymmetric digital signor 180. The asymmetric digital signor 180 signs the bound activation file 182 using the private key 164 by any algorithm that signs a data block such as, but not limited to, RSA, RSA-DSS, Full Domain Hash, DSA, ECDSA, and SHA algorithms as are known in the art. The signed activation file 178 may then be sent to the handset device 100 as the asymmetrically digitally signed activation file 214. Alternatively, asymmetric digital signing may be performed by the controller 170 rather than via a separate asymmetric digital signing module 180.

A dedicated asymmetric signature verification module 190 may be operatively coupled to the controller 170 for the purpose of performing signature verification. Alternatively, asymmetric signature verification may be performed by the controller 170 rather than via a separate asymmetric signature verification module 190. The handset device 100 may receive a message from the wireless network device 200 that is, in turn, passed to the SIM card device 150 as a network message 215. This network message 215 may be an asymmetrically digitally signed file 215 containing updated locking parameters. The signature of the network message 215 may be verified by the SIM card 150 using the root certificate 168 to insure the authenticity of the message 215. The controller 170, or the asymmetric signature verification module 190, may perform this verification. If the asymmetric signature verification module 190 is used, then the verification status 174 may be passed back to the controller 170.

Subsidy security is insured by verifying the signature of the network message 215 against a trusted certificate 168. This verification may be a single level, where the digital signature of the network message 215 is verified against the root certificate 168. Alternatively, the network message 215 may further contain a certificate chain, consisting of one or more certificates, where each certificate is verified against a previously validated certificate in a hierarchy. For example, the network message 215 may include an intermediate certificate and a device certificate in addition to the digital signature. The SIM card would use the root certificate 168 to first validate the received intermediate certificate. The validated intermediate certificate would then be used to validate the received device certificate. The validated device certificate would then be used to validate the signature of the network message 215.

Operational instructions, or software, executing on the SIM card controller 170 is stored in memory 160 that may include a single memory device or a plurality of memory devices. Such memory 160 may include any memory element that stores digital data including, but not limited to, RAM, ROM, flash memory, hard disk drive, distributed memory such as servers on a network, or CD-ROM or any suitable storage medium. It will be recognized that such memory may be integrated with the controller or take any suitable configuration.

The memory 160 may be operative to store the activation file template 162. The activation file template 162 personalizes the SIM card to a specific network provider. The activation file template 162 holds a lock state, such as locked or unlocked. The activation file template 162 holds locking parameters, such as a subsidy lock state, home public land mobile network (HPLMN) information, international mobile subscriber identifier (IMSI), and group identifiers (GID1/GID2), that are coded with values that bind the handset to the issuing service provider and the customer. In response to a valid activation file request 212, the SIM card 150 may bind the activation file template 162 to the particular handset device 100 by inserting a binding parameter, such as a handset identifier 116 received with the activation file request 212, into the activation file template 162, to generate a bound activation file 182. The bound activation file 182 is then asymmetrically digitally signed by the SIM card 150 using the private key 164 on the SIM card 150 prior to being sent to the handset device 100. The handset device 100 will verify the digital signature of this asymmetrically digitally signed activation file 214 prior to installation of the activation file 112 into the handset device 100.

The activation file template 162 may include a digital signature—one that is provisioned by the network provider prior to installation of the card 150. For example, the network provider may provision a common activation file template 162 in a large number of SIM cards 150. This common activation file template 162 would be valid for a large number of SIM cards 150. Each activation file template 162 may be verified against a root certificate 168 that is securely stored in the card 150 to prevent tampering. In the event that the network operator were to need to update or replace the common activation file template 162, then a new activation file template may be sent to each SIM card via the network communicating with each handset device 100. The new activation file template may be digitally signed by the network provider. The SIM card 150 may verify the digital signature of the updated activation file template using the root certificate 168 prior to storing the new template in the activation file template 162 location in the SIM card memory 160.

The memory 160 may be operative to store a private key 164 used for asymmetric digital signing of the bound activation file 182 prior to sending an asymmetrically digitally signed activation file 214 to the handset device. The private key 164 must be secured on the SIM card 150 such that it cannot be read externally. The memory 160 may be operative to store a software application 166 for execution by the SIM card controller 170.

The memory 160 may be operative to store a root certificate 168 containing a public key that may be used to validate received network messages 215. The memory 160 may be operative to store an unlock password 169 or, alternatively, a hash of an unlock password. The unlock password 169 may be compared to a password provided by the handset device 100 as part of an activation file request 212 for unlocking the handset.

The wireless network device 200 is a device enabled for wireless communication with the handset device 100 and that serves as a link between the handset device 100 and the overall wireless network. The wireless network device 200 may include a controller 204, memory 202, and a transceiver 206. The controller 204 may be operatively coupled to the memory 202 by a memory bus 208 and operatively coupled to the transceiver 206 by a transceiver bus 210. A wireless network device 200 may be embodied as any suitable operating device in a wireless network including, but not limited to, a base station, a hub, a repeating transmitter, a mobile station, or combinations thereof. The wireless network device 200 provides a path for wireless communications between the handset device 100 and the controlling services of the wireless network provider.

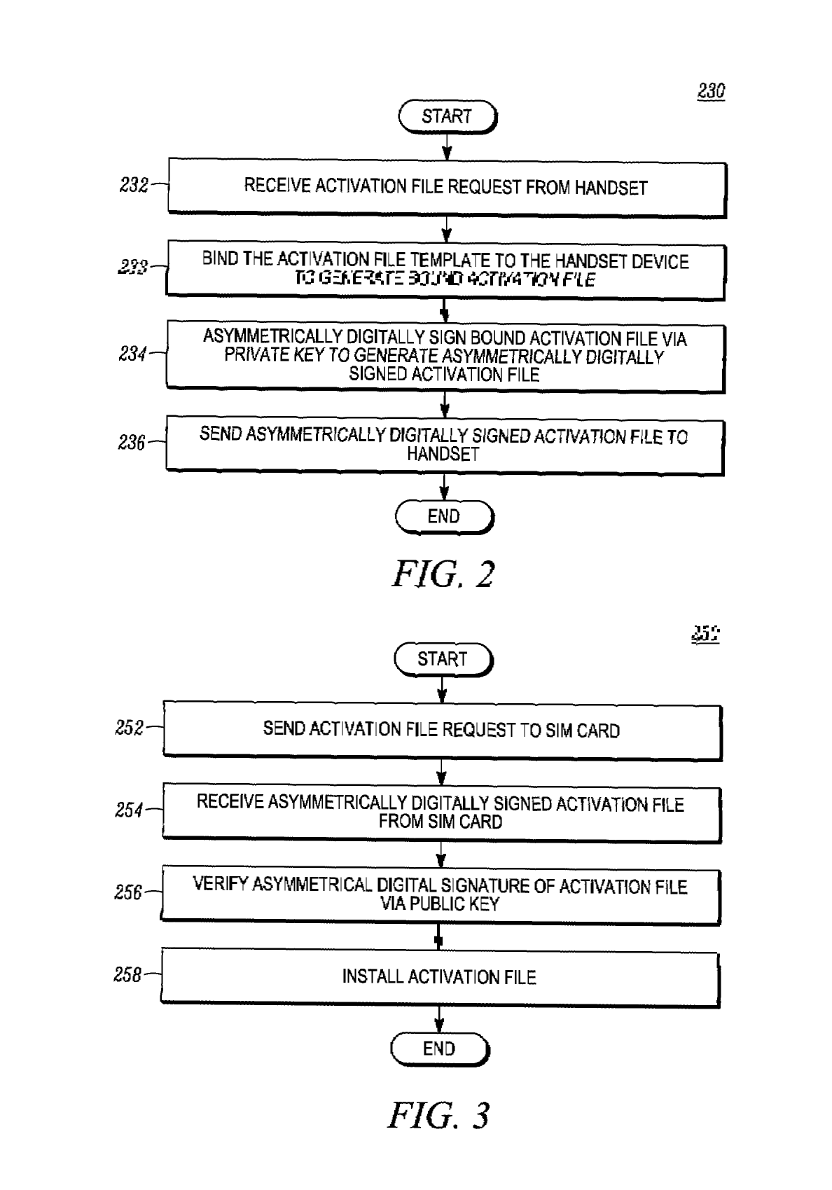

FIG. 2 is a flowchart of operating steps performed by a SIM card employing one example of a method of subsidy control of a handset device via a SIM card in accordance with one embodiment of the invention. In particular, one example of a method 230 performed by the SIM card 150 for activating an inactive, locked handset device 100 is shown. The process begins in step 232 where the SIM card 150 receives an activation file request 212 from the handset device 100. For example, when an operator inserts the SIM card 150 into the handset device 100, the handset device 100 may recognize that it is inactive and automatically send an activation file request 212 to the SIM card 150. The activation file request 212 may include the handset identifier 116, such as the IMEI. Preferably the handset identifier 116 is the unique ID of the controller IC as discussed above. Alternatively, the handset device 100 may send the activation file request 212 as a result of an over-the-air (OTA) action by the wireless network device 100. The wireless network provider may send an activation request directly to the handset 100. Standard OTA methods, such as SIM-specific SMS messages, may be used by the wireless network to store or update the activation file template 162 onto the SIM card. (SIM-specific SMS messages are received by the handset and stored to the SIM card, which then processes the command contained inside the message according to a SIM-manufacturer-proprietary protocol.) This may optionally also cause the handset to send the activation request 212 to the SIM card. In step 233, the SIM card 150 binds the activation file template 162 to the handset device 100 to thereby generate a bound activation file 182 for the handset 100. For example, the handset identifier 116, such as the IMEI, may be inserted in to the activation file template 162 such that the activation file may only be used with this particular handset 100. In step 234, the SIM card 150 asymmetrically digitally signs the bound activation file 182 via the private key 164 to thereby generate an asymmetrically digitally signed activation file 178. The digital signing method may be any algorithm that signs a data block such as, but not limited to, RSA, RSA-DSS, Full Domain Hash, DSA, ECDSA, and SHA algorithms as are known in the art. In step 236, the SIM card 150 sends the asymmetrically digitally signed activation file 214 to the handset device 100. To insure subsidy security, the SIM card 150 may then be disabled from activating additional handset devices 100 without network operator intervention.

FIG. 3 is a flowchart of operating steps performed by a handset device employing one example of a method of subsidy control of a handset device via a SIM card in accordance with one embodiment of the invention. In particular, one example of a method 250 performed by the handset device 100 for activation is shown. The process begins in step 252 where the handset device 100 sends the activation file request 212 to the SIM card 150. In step 254, the handset receives the asymmetrically digitally signed activation file 214 from the SIM card. The handset may also receive a certificate chain consisting of a device certificate and intermediate certificate. In step 256, the handset device 100 verifies the asymmetric digital signature of the activation file 214 via the public key contained in the root certificate 114. If a certificate chain is received with the activation file 214, then the public key may be used to validate the received intermediate certificate, which is then used to validate the received device cert, which is then used to validate the signature on the received activation file. In addition, the handset device 100 may compare the handset identifier bound to the signed activation file 214 by the SIM card 150 with the handset identifier 116 held in the handset 100 to insure that the activation file corresponds to this handset 100. Installation of the activation file is bypassed if the signature of the activation file does not verify. If the activation file does verify then, in step 258, the handset device 100 installs the activation file 112 into memory 110. As a result, the handset device 100 is activated, meaning that the handset will now accept SIM cards according to the subsidy lock parameters contained within the activation file.

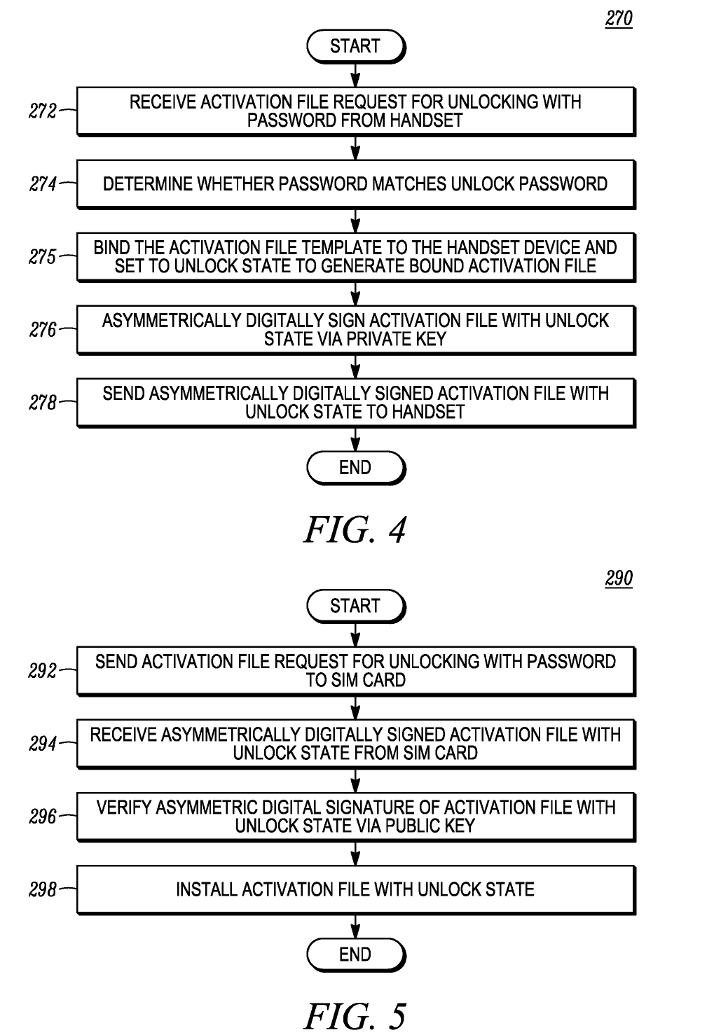

FIG. 4 is a flowchart of operating steps performed by a SIM card employing one example of a method of subsidy control of a handset device via a SIM card in accordance with one embodiment of the invention. In particular, one example of a method 270 performed by the SIM card 150 for unlocking an active, locked handset device 100 is shown. In this example, the handset device 100 is active and operative to a wireless network using the SIM card 150 that has been installed or otherwise coupled to the handset 100. However, it is desirable, for whatever reason, that the handset 100 be subsidy unlocked. The process begins in step 272 where the SIM card 150 receives an activation file request for unlocking 212 from the handset device 100. For example, an operator may select an unlocking option from a menu on the handset device 100 and then enter in a password 132 via the user interface 140 on the handset 100. If the inserted SIM card is not accepted by the subsidy lock checking that is done using the installed activation file, then the phone may automatically prompt the user for the unlock password and build and send the activation request for unlocking to the SIM once the password is entered. The activation file request 212 from the handset device 100 may include this password 132. Alternatively, the handset device 100 may send the activation file request for unlocking 212 as a result of an over-the-air (OTA) action by the wireless network device 100. The wireless network provider may send an unlocking request directly to the handset 100. In step 274, the SIM card 150 determines whether the password 132 included in the activation file request 212 matches the unlock password 169 in the SIM card. In the event of a network-initiated unlocking request, it would not be necessary to send the password. The SIM card device 150 would instead verify a digital signature on the activation file request for unlocking 212 to insure security of the SIM lock. Further binding, signing, or sending of the activation file is bypassed if the password does not verify.

A network-initiated unlock request may be signed by the network, bound to the SIM serial number (IMSI). Alternatively, a network-initiated unlock request may be signed by the network, bound to the handset serial number (IMEI) or be bound to both the SIM IMSI and the handset IMEI. In addition, the network-initiated unlock request may be executed as a challenge/response that includes a nonce so as to protect against a replay attack as is known in the art. The network may also include the IMEI of the device in the network-initiated unlock request so that the request is only valid for the desired device & SIM IMSI number pair. A network-initiated unlock would use OTA to install a new activation file template (whose lock state is set to unlocked), which would trigger the phone to send an activation request (without password) which would then be processed to unlock the phone. In step 275, the SIM card 150 binds the activation file template 162 to the handset device 100 and sets the activation file template to the unlock state to thereby generate a bound activation file 182 for the handset 100.

In step 276, if the correct password was entered, the SIM card 150 asymmetrically digitally signs the bound activation file 182 via the private key 164. The digital signing method may be any algorithm that signs a data block such as, but not limited to, RSA, RSA-DSS, Full Domain Hash, DSA, ECDSA, and SHA algorithms as are known in the art. Signing of the activation file is bypassed if the activation file does not verify. In step 278, the SIM card 150 sends the asymmetrically digitally signed activation file with unlock state 214 to the handset device 100.

FIG. 5 is a flowchart of operating steps performed by a handset device employing one example of a method of subsidy control of a handset device via a SIM card in accordance with one embodiment of the invention. In particular, one example of a method 290 performed by the handset device 100 for subsidy unlock is shown. The process begins in step 292 where the handset device 100 sends the activation file request for unlocking 212 to the SIM card 150. This request contains the unlocking password and the handset identifier. In step 294, the handset 100 receives the asymmetrically digitally signed activation file 214 from the SIM card. In step 296, the handset device 100 verifies the asymmetric digital signature of the activation file 214 via the public key 114. In addition, the handset device 100 may compare the handset identifier bound to the signed activation file 214 by the SIM card 150 with the handset identifier 116 held in the handset 100 to insure that the activation file corresponds to this handset 100. In step 298, the handset device 100 installs the activation file with unlock state 112 into memory 110. As a result, the handset device 100 is unlocked. Installation of the activation file is bypassed if the signature of the activation file does not verify.

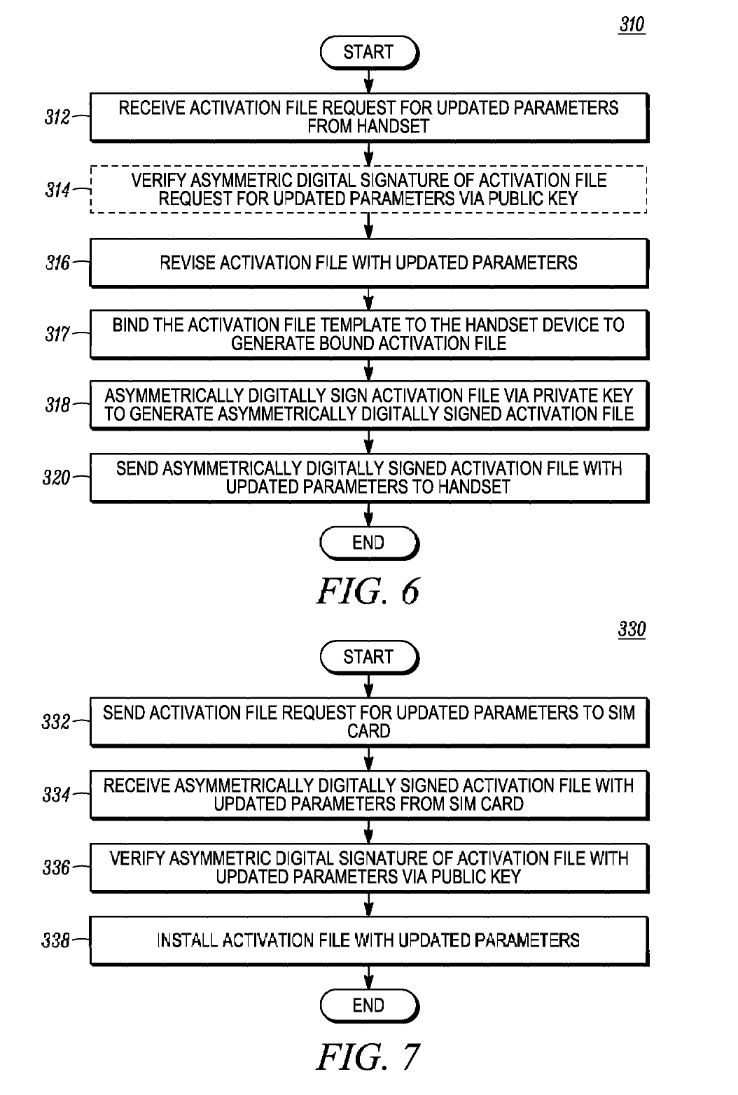

FIG. 6 is a flowchart of operating steps performed by a SIM card employing one example of a method of subsidy control of a handset device via a SIM card in accordance with one embodiment of the invention. In particular, one example of a method 310 performed by the SIM card 150 for updating parameters in the active, locked handset device 100 is shown. In this example, the handset device 100 is active and operative to a wireless network using the SIM card 150 that has been installed or otherwise coupled to the handset 100. However, it is desirable, for whatever reason, to update the subsidy parameters in the SIM card 150 and the handset device 100. The process begins in step 312 where the SIM card 150 receives an activation file request 212 for updated parameters from the handset device 100. For example, the handset device 100 may send the activation file request for updating parameters 212 as a result of an over-the-air (OTA) action by the wireless network device 100. The wireless network provider may send an update parameter request directly to the handset 100. This request may further include update parameters. The activation file request for updating parameters 212 that is sent from the handset device 100 to the SIM card 150 may therefore include the updated parameters. In this case, the activation file request for updating parameters 212 may include an asymmetric digital signature from the wireless network provider. An optional step 314 may be performed where the SIM card 150 verifies the asymmetric digital signature of the activation file request for updating parameters 212. Alternatively, the updated parameters may be sent in other messages between the handset device 100 and the SIM card 150 such as by a short message service (SMS) SIM-specific message. Further revision, binding, or signing of the activation file template is bypassed if the signature of the activation file request does not verify. If the signature does verify, then in step 316, the SIM card 150 revises the activation file template 162 with updated parameters. In step 317, the SIM card 150 binds the activation file template 162 to the handset device 100 to thereby generate a bound activation file 182 for the handset 100. In step 318, the SIM card 150 asymmetrically digitally signs the bound activation file 182 with the updated subsidy lock parameters via the private key 164. During signing, the SIM card 150 may bind the handset identifier 116 from the handset device 100 to the asymmetrically digitally signed activation file 214 such that this signed file may only be used with this particular handset 100. The digital signing method may be any algorithm that signs a data block such as, but not limited to, RSA, RSA-DSS, Full Domain Hash, DSA, ECDSA, and SHA algorithms as are known in the art. In step 320, the SIM card 150 sends the asymmetrically digitally signed activation file with updated parameters 214 to the handset device 100.

FIG. 7 is a flowchart of operating steps performed by a handset device employing one example of a method of subsidy control of a handset device via a SIM card in accordance with one embodiment of the invention. In particular, one example of a method 330 performed by the handset device 100 for updating parameters in an activated handset 100 is shown. The process begins in step 332 where the handset device 100 sends the activation file request for updating parameters 212 to the SIM card 150. This activation request for updating parameters could be sent in response to receiving new parameters OTA at the handset, or it could be triggered by a SIM toolkit refresh operation of the activation file on the SIM card after it was updated using SIM-specific SMS messages. In this case the activation request would not contain the new parameters, since they would already be written into the activation file in the SIM via SIM-specific messaging. In step 334, the handset 100 receives the asymmetrically digitally signed activation file 214 from the SIM card 150. In step 336, the handset device 100 verifies the asymmetric digital signature of the activation file 214 via the public key 114. In addition, the handset device 100 may compare the handset identifier bound to the signed activation file 214 by the SIM card 150 with the handset identifier 116 held in the handset 100 to insure that the activation file corresponds to this handset 100. Installation of the activation file is bypassed if the signature of the activation file does not verify. In step 338, if the signature check and handset identifier check passed, the handset device 100 installs the activation file with updated parameters 112 into memory 110. As a result, the subsidy parameters of the handset device 100 are updated.

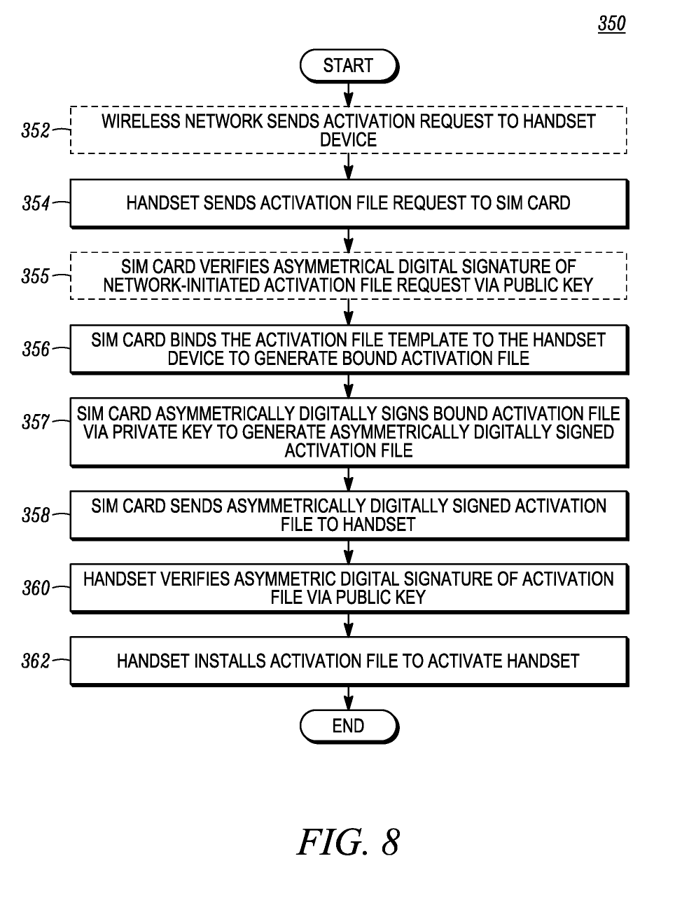

FIG. 8 is a flowchart of operating steps performed by an apparatus employing one example of a method of subsidy control of a handset device via a SIM card in accordance with one embodiment of the invention. In particular, one example of a method 350 performed by the apparatus 10 for activating an inactive, locked handset device 100 is shown. The process may optionally begin in step 352, where the wireless network device 200 sends an activation request to the handset device 100. In this case, an over-the-air (OTA) activation is initiated. If the handset has not been activated, then it will not accept any SIM card. However, the handset could read the SIM parameters in order to identify itself to the network, while remaining in a functionally locked state, until a successful OTA activation is initiated by the network. The handset could then be activated by the network and made operative. Alternatively, when an operator inserts the SIM card 150 into the handset device 100, the handset device 100 may recognize that it is inactive and automatically initiate activation. In step 354, the handset device 100 sends an activation file request 212 to the SIM card 150. The activation file request 212 may include the handset identifier 116, such as the IMEI or, preferably, the unique ID of the controller IC. The activation file request for activation 212 may include an asymmetric digital signature from the wireless network provider. If so, then an optional step 355 may be performed where the SIM card 150 verifies the asymmetric digital signature of the activation file request for activation. Further binding, signing, or sending of the activation file is bypassed if the signature of the activation file request does not verify. In step 356, the SIM card 150 binds the activation file template 162 to the handset device 100—such that the activation file may only be used with this particular handset 100—to thereby generate a bound activation file 182 for the handset 100. In step 357, the SIM card 150 asymmetrically digitally signs the activation file 182 via the private key 164. The digital signing method may be any algorithm that signs a data block such as, but not limited to, RSA, RSA-DSS, Full Domain Hash, DSA, ECDSA, and SHA algorithms as are known in the art. In step 358, the SIM card 150 sends the asymmetrically digitally signed activation file 214 to the handset device 100. In step 360, the handset device 100 verifies the asymmetric digital signature of the activation file 214 via the public key 114. In addition, the handset device 100 may compare the handset identifier bound to the signed activation file 214 by the SIM card 150 with the handset identifier 116 held in the handset 100 to insure that the activation file corresponds to this handset 100. In step 362, the handset device 100 installs the activation file 112 into memory 110. As a result, the handset device 100 is activated. Installation of the activation file is bypassed if the signature of the activation file does not verify.

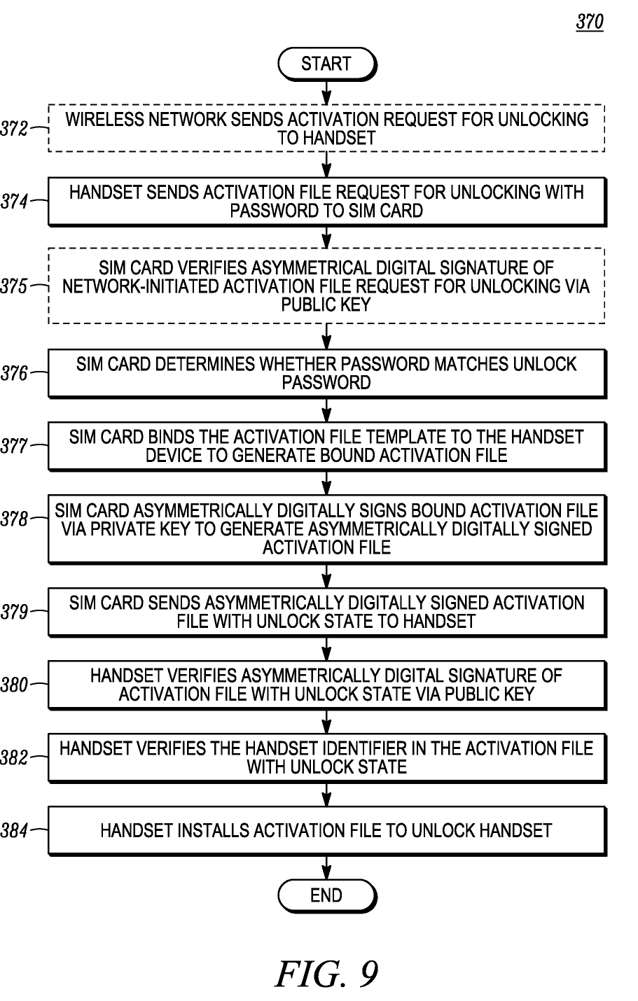

FIG. 9 is a flowchart of operating steps performed by an apparatus employing one example of a method of subsidy control of a handset device via a SIM card in accordance with one embodiment of the invention. In particular, one example of a method 370 performed by the apparatus 10 for unlocking an active, locked handset device 100 is shown. In this example, the handset device 100 is active and operative to a wireless network using the SIM card 150 that has been installed or otherwise coupled to the handset 100. However, it is desirable, for whatever reason, that the handset 100 be subsidy unlocked. The process may optionally begin in step 372, where the wireless network device 200 sends an activation request for unlocking to the handset device 100. In this case, an over-the-air (OTA) activation is initiated. The wireless network provider may send an unlocking request directly to the handset 100. Alternatively, a user may initiate the unlocking process by selecting an unlocking option from a menu on the handset device 100 and then enter in a password 132 via the user interface 140 on the handset 100. In step 374 the handset device 100 sends the activation file request for unlocking 212 to the SIM card 150. The activation file request 212 from the handset device 100 may include this password 132. The activation file request for unlocking 212 may include an asymmetric digital signature from the wireless network provider. If so, then an optional step 375 may be performed where the SIM card 150 verifies the asymmetric digital signature of the activation file request for updating parameters 212. Further password checking of the activation file request and binding, signing, or sending of the activation file is bypassed if the activation file request signature does not verify. If the signature does verify, then in step 376, the SIM card 150 determines whether the password 132 included in the activation file request 212 matches the unlock password 169 in the SIM card. If the unlocking is initiated by the wireless network provider, then the password may not be needed. Rather, subsidy unlock verification is performed based on verification of a digital signature provided by the network provider along with the unlocking request. A network-initiated unlock request may be signed by the network, bound to the SIM serial number (IMSI). In addition, the network-initiated unlock request may be executed as a challenge/response that includes a nonce so as to protect against a replay attack. The network may also include the IMEI of the device in the network-initiated unlock request so that the request is only valid for the desired device & SIM IMSI number pair. Further binding, signing, or sending of the activation file is bypassed if the password of the activation file request does not verify.

If the password does verify, then in step 377, the SIM card 150 binds the activation file template 162 to the handset device 100—such that the activation file may only be used with this particular handset 100—to thereby generate a bound activation file 182 for the handset 100. The SIM card 150 also sets the activation file template to the unlock state. In step 378, the SIM card 150 asymmetrically digitally signs the bound activation file 182 with an unlock state via the private key 164. During signing, the SIM card 150 may bind the handset identifier 116 from the handset device 100 to the asymmetrically digitally signed activation file 214 such that this signed file may only be used with this particular handset 100. The digital signing method may be any algorithm that signs a data block such as, but not limited to, RSA, RSA-DSS, Full Domain Hash, DSA, ECDSA, and SHA algorithms as are known in the art. In step 379, the SIM card 150 sends the asymmetrically digitally signed activation file with unlock state 214 to the handset device 100. In step 380, the handset device 100 verifies the asymmetric digital signature of the activation file 214 via the public key 114. Further verification or installation of the activation file is bypassed if the signature of the activation file does not verify. If the signature does verify, then in step 382 the handset device 100 may compare the handset identifier bound to the signed activation file 214 by the SIM card 150 with the handset identifier 116 held in the handset 100 to insure that the activation file corresponds to this handset 100. In step 384, if the signature checking and handset identifier check pass, the handset device 100 installs the activation file with unlock state 112 into memory 110. As a result, the handset device 100 is unlocked.

The exemplary embodiment is extendable to meeting industry standards, such as 3GPP 22.022, wherein several locking layers are described. For example, the 3GPP 22.022 describes personalization (locking) layers including network (HPLMN), service provider (GID1), corporate (GID2), IMSI 3 digit, and IMSI all digit. By providing asymmetric digitally signed activation files for each of the five personalization layers, all five personalization layers may be implemented in the handset.

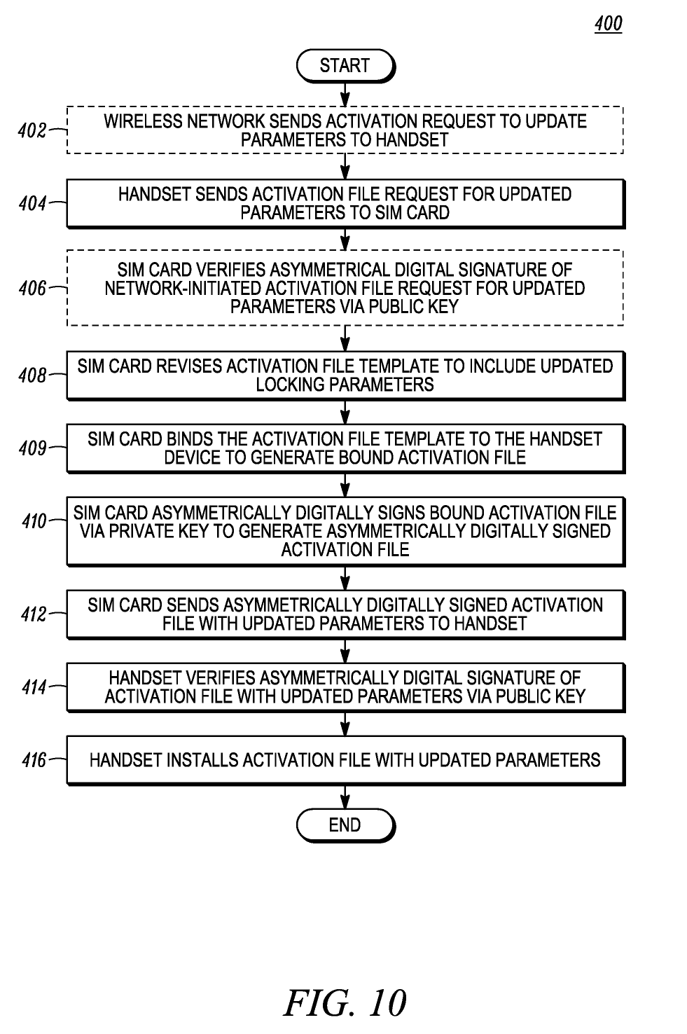

FIG. 10 is a flowchart of operating steps performed by an apparatus employing one example of a method of subsidy control of a handset device via a SIM card in accordance with one embodiment of the invention. In particular, one example of a method 400 performed by the apparatus 10 for updating parameters in the active, locked handset device 100 is shown. In this example, the handset device 100 is active and operative to a wireless network using the SIM card 150 that has been installed or otherwise coupled to the handset 100. However, it is desirable, for whatever reason, to update the subsidy parameters in the SIM card 150 and the handset device 100. The process may begin in step 402 where the wireless network provider sends an activation request to parameters directly to the handset 100. This request may further include the update parameters. Alternatively, the updated parameters may be sent in other messages between the handset device 100 and the SIM card 150 such as by a short message service (SMS) message. In step 404, an activation file request for updating parameters 212 is sent from the handset device 100 to the SIM card 150. The activation file request for updating parameters 212 may include an asymmetric digital signature from the wireless network provider. If so, then an optional step 406 may be performed where the SIM card 150 verifies the asymmetric digital signature of the activation file request for updating parameters 212. Further revising, signing, or sending of activation file is bypassed if the signature of the activation file request does not verify. If verified, then in step 408, the SIM card 150 revises the activation file 162 with the updated parameters.

In step 410, the SIM card 150 binds the activation file template 162 to the handset device 100—such that the activation file may only be used with this particular handset 100—to thereby generate a bound activation file 182 for the handset 100. In step 410, the SIM card 150 asymmetrically digitally signs the bound activation file 182 with the updated lock state and update locking parameters via the private key 164. The digital signing method may be any algorithm that signs a data block such as, but not limited to, RSA, RSA-DSS, Full Domain Hash, DSA, ECDSA, and SHA algorithms as are known in the art. In step 412, the SIM card 150 sends the asymmetrically digitally signed activation file with updated parameters 214 to the handset device 100. In step 414, the handset device 100 verifies the asymmetric digital signature of the activation file 214 via the public key 114. Further verification or installation of the activation file is bypassed if the signature of the activation file does not verify. In addition, the handset device 100 may compare the handset identifier bound to the signed activation file 214 by the SIM card 150 with the handset identifier 116 held in the handset 100 to insure that the activation file corresponds to this handset 100. In step 416, if signature check and handset identifier checks pass, the handset device 100 installs the activation file with updated parameters 112 into memory 110. As a result, the subsidy parameters of the handset device 100 are updated.

By default, the SIM card 150 may be enabled to only activate a single handset device 100 to prevent unauthorized activation, unlocking, or parameter updating. Only one handset may be unlocked for each SIM card 150 unless the unlocking is initiated by the wireless network. However, the SIM card 150 may be further enabled to activate additional handsets 100 though the use of messages transmitted from the wireless network into the handset device 100 and passed on to the SIM card 150. Asymmetric digital signatures may be used to secure these messages which would be verified in the SIM card device 150 using the root certificate 168 and intermediate and device certificates received along with these messages and asymmetric digital signature verification. In addition, SIM card revocation could be supported using asymmetrically digitally signed messages from the wireless network. The asymmetrically digitally signed activation file 214 received by the handset from the SIM card contains an asymmetric digital signature. The handset preferably also receives a certificate chain consisting of a device certificate and intermediate certificate. If a certificate chain is received with the activation file, then the public key may be used to validate the received intermediate certificate, which is then used to validate the received device cert, which is then used to validate the signature on the received activation file.

The above detailed description of the invention, and the examples described therein, has been presented for the purposes of illustration and description. While the principles of the invention have been described above in connection with a specific device, it is to be clearly understood that this description is made only by way of example and not as a limitation on the scope of the invention.

What is claimed is:

1. A method for subsidy control of a handset device via a SIM card comprising:
receiving an activation file request from a handset device;
binding an activation file template to the handset device to generate a bound activation file;
asymmetrically digitally signing the bound activation file via a private key to generate an asymmetrically digitally signed activation file; and
sending the asymmetrically digitally signed activation file to the handset device.

2. The method of claim 1 wherein the activation file request is for unlocking of the handset device.

3. The method of claim 2 further comprising determining whether a password included with the activation file request matches an unlock password prior to asymmetrically digitally signing the activation file.

4. The method of claim 1 wherein the activation file request is for updating parameters of the activation file template.

5. The method of claim 4 further comprising revising the activation file template with updated parameters.

6. The method of claim 1 further comprising verifying an asymmetric digital signature of the activation file via a public key.

7. The method of claim 1 wherein the asymmetrically digitally signed activation file may only be sent to one handset device.

8. A method for subsidy control of a handset device via a SIM card comprising:
sending an activation file request to a SIM card;
receiving an asymmetrically digitally signed activation file from the SIM card;
verifying the asymmetric digital signature of the activation file via a public key; and
installing the verified activation file.

9. The method of claim 8 wherein the activation file request is for unlocking a handset device.

10. The method of claim 8 wherein the activation file request is for updating parameters of the activation file.

11. The method of claim 8 further comprising receiving an activation request from a wireless network device prior to sending an activation file request to a SIM card.

12. The method of claim 8 further comprising comparing a handset identifier bound to the asymmetrically digitally signed activation file with a handset identifier held in a handset device prior to installing the activation file.

13. A method for subsidy control of a handset device via a SIM card comprising:
sending an activation file request from a handset device to a SIM card that is operatively coupled to the handset device;
binding an activation file template to the handset device to generate a bound activation file;
asymmetrically digitally signing the bound activation file via a private key to generate an asymmetrically digitally signed activation file;
sending the asymmetrically digitally signed activation file from the SIM card to the handset device;
verifying the asymmetric digital signature of the activation file using a public key on the handset device; and
installing the verified, digitally signed activation file on the handset device.

14. The method of claim 13 wherein the activation file request is for unlocking of the handset device.

15. The method of claim 14 further comprising determining whether a password included with the activation file request matches an unlock password prior to asymmetrically digitally signing the activation file.

16. The method of claim 13 wherein the activation file request is for updating parameters of the activation file.

17. The method of claim 16 further comprising revising the activation file template with updated parameters prior to asymmetrically digitally signing the activation file.

18. The method of claim 13 further comprising verifying an asymmetric digital signature of the activation file request.

19. The method of claim 13 further comprising receiving an activation request from a wireless network device prior to sending an activation file request from the handset device to the SIM card.

20. The method of claim 19 wherein the activation request from the wireless network device is for unlocking of the handset device.

21. The method of claim 19 wherein the activation request from the wireless network device is bound to an identifier on the SIM card.

22. The method of claim 19 wherein the activation request from the wireless network device is bound to an identifier on the handset device.

23. The method of claim 19 wherein the activation request from the wireless network device is in the form of as a challenge/response including a nonce to protect against a replay attack.

24. The method of claim 19 wherein the activation request from the wireless network device is for updating parameters of the activation file.

25. The method of claim 13 further comprising comparing a handset identifier bound to the asymmetrically digitally signed activation file with a handset identifier held in the handset device prior to installing the verified, digitally signed activation file.

26. A handset device enabled for subsidy control via a SIM card comprising:
memory operative to store an activation file and a public key; and
a controller operatively coupled to the memory wherein the controller is operative to send an activation file request to a SIM card, to receive an asymmetrically digitally signed activation file from the SIM card, to verify the asymmetric digital signature of the activation file via the public key and to install the activation file in the memory.

27. The device of claim 26 wherein the controller is further operative to send an activation file request for unlocking the handset device, to receive a password and to include the password in the activation file request for unlocking the handset device.

28. The device of claim 26 wherein the controller is further operative to receive an activation file request for updating parameters of the activation file.

29. The device of claim 26 further comprising a transceiver operatively coupled to the controller and operative to transmit and receive wireless messages between the handset device and a wireless network device.

30. The device of claim 26 wherein the controller is further operative to compare a handset identifier bound to the activation file with a handset identifier held in the handset device prior to installing the activation file in memory.

31. The device of claim 26 wherein the controller is further operative to determine the subsidy lock state of the activation file and to accept or reject a SIM card based on this state.

32. A SIM card device enabled for subsidy control of a handset device comprising:
memory operative to store an activation file template and a private key; and
a controller operatively coupled to the memory wherein the controller is operative to receive an activation file request from a handset device, to bind the activation file template to the handset device to generate a bound activation file, to asymmetrically digitally sign the bound activation file via the private key to generate an asymmetrically digitally signed activation file; and to send the asymmetrically digitally signed activation file to the handset device.

33. The device of claim 32 wherein the controller is operative to receive an activation file request for unlocking of the handset device.

34. The device of claim 33 wherein the memory is further operative to store an unlock password and wherein the controller is further operative to determine whether a password included with the activation file request matches the unlock password prior to asymmetrically digitally signing the activation file.

35. The device of claim 32 wherein the controller is operative to receive an activation file request is for updating parameters of the activation file.

36. The device of claim 33 wherein the controller is further operative to revise the activation file template with updated parameters prior to asymmetrically digitally signing the activation file.

37. The device of claim 32 wherein the controller is further operative to verify an asymmetric digital signature of the activation file request via a public key.

38. The device of claim 37 wherein the controller is operative to send an asymmetrically digitally signed activation file to subsidy unlock the handset device without verifying an unlocking password.

39. A storage medium comprising executable instructions that when executed by one or more processing units, causes the one or more processing units to:
receive an activation file request from a handset device;
bind an activation file template to the handset device to generate a bound activation file;
asymmetrically digitally sign the bound activation file via a private key to generate an asymmetrically digitally signed activation file; and
send the asymmetrically digitally signed activation file to the handset device.

40. The storage medium of claim 39 comprising executable instructions that when executed by one or more processing units, causes the one or more processing units to determine whether a password included in the activation file request matches an unlock password prior to asymmetrically digitally signing the activation file.

41. The storage medium of claim 39 comprising executable instructions that when executed by one or more processing units, causes the one or more processing units to verify an asymmetric digital signature of the activation file request prior to asymmetrically digitally signing the activation file.

42. The storage medium of claim 39 comprising executable instructions that when executed by one or more processing units, causes the one or more processing units to update the activation file template with updated parameters prior to asymmetrically digitally signing the activation file.

43. A storage medium comprising executable instructions that when executed by one or more processing units, causes the one or more processing units to:
send an activation file request to a SIM card;
receive an asymmetrically digitally signed activation file from the SIM card;
verify the asymmetric digital signature of the activation file via a public key; and
install the activation file.

44. The storage medium of claim 43 comprising executable instructions that when executed by one or more processing units, causes the one or more processing units to send an activation file request for unlocking a handset device to the SIM card.

45. The storage medium of claim 44 comprising executable instructions that when executed by one or more processing units, causes the one or more processing units to determine whether a password included with the activation file request matches an unlock password prior to asymmetrically digitally signing the activation file.

46. The storage medium of claim 43 comprising executable instructions that when executed by one or more processing units, causes the one or more processing units to send an activation file request for updating parameters of the activation file to the SIM card.

47. The storage medium of claim 43 comprising executable instructions that when executed by one or more processing units, causes the one or more processing units to receive an activation request from a wireless network device wherein the activation request is bound to an identifier on the SIM card.

48. The storage medium of claim 43 comprising executable instructions that when executed by one or more processing units, causes the one or more processing units to receive an activation request for upgrading parameters of the activation file from a wireless network device.

49. The method of claim 43 comprising executable instructions that when executed by one or more processing units, causes the one or more processing units to receive an activation request for upgrading parameters of the activation file from a wireless network device wherein, the activation request is in the form of a challenge/response including a nonce to protect against a replay attack.
